(19) United States
(12) Patent Application Publication
(10) Pub. No.: US 2023/0400715 A1
(43) Pub. Date: Dec. 14, 2023

(54) OPTICAL MODULATION ELEMENT, OPTICAL SHUTTER, AND OPTICAL MODULATION METHOD

(71) Applicant: FUJIFILM Corporation, Tokyo (JP)

(72) Inventors: Masashi ONO, Kanagawa (JP); Masahiro TAKATA, Kanagawa (JP)

(73) Assignee: FUJIFILM Corporation, Tokyo (JP)

(21) Appl. No.: 18/456,531

(22) Filed: Aug. 28, 2023

Related U.S. Application Data
(63) Continuation of application No. PCT/JP2022/002991, filed on Jan. 27, 2022.

(30) Foreign Application Priority Data
Mar. 10, 2021 (JP) 2021-037924

(51) Int. Cl. G02F 1/015

(52) U.S. Cl. CPC G02F 1/015; G02F 2201/12

(57) ABSTRACT

Provided are an optical modulation element including a substrate 11; an electrode layer 12 provided on the substrate 11; a dielectric layer 13 provided on the electrode layer 12; and a light absorbing layer 14 provided on the dielectric layer 13 and including inorganic nanoparticles, in which the inorganic nanoparticles exhibit localized surface plasmon resonance by light irradiation, an optical shutter including the optical modulation element, and an optical modulation method including dynamically modulating reflected light or transmitted light of light incident into the optical modulation element by changing a voltage to be applied to the light absorbing layer of the optical modulation element.

### CROSS-REFERENCE TO RELATED APPLICATIONS

This application is a Continuation of PCT International Application No. PCT/JP2022/002991 filed on Jan. 27, 2022, which claims priority under 35 U.S.C § 119(a) to Japanese Patent Application No. 2021-037924 filed on Mar. 10, 2021. Each of the above application(s) is hereby expressly incorporated by reference, in its entirety, into the present application.

### BACKGROUND OF THE INVENTION

### 1. Field of the Invention

The present invention relates to an optical modulation element. More specifically, the present invention relates an optical modulation element that dynamically changes selective absorption of light. In addition, the present invention relates to an optical shutter and an optical modulation method.

### 2. Description of the Related Art

Research for wavelength-selectively controlling optical characteristics such as absorption/reflection/transmission using a nanophotonic technique has been actively conducted. In particular, for example, in a near infrared range, a heat shielding material that cuts only near infrared light in sunlight, an electrochromic material that dynamically controls light shielding of near infrared light, or the like has been researched, developed, or put into practice. In addition, for example, in a mid- to far-infrared range, an investigation on heat radiation/radiative cooling where heat radiation of a thing is controlled by controlling of an emissivity in the 8-13 μm band that is an atmospheric window region has been actively conducted. Further, as long as an infrared emissivity can be dynamically controlled, a self-adaptive system having a cooling/heat radiation function only in hot weather or at a high temperature can be implemented, and an investigation on the self-adaptive system has been actually conducted. That is, along with the development of nanotechnology or optical design techniques, optical characteristics that cannot be exhibited with a single material not only in a visible range but also in a near infrared to infrared range and a wavelength range called a millimeter wave or a microwave have been implemented, and the application thereof has been actively searched.

As a control method of optical characteristics in a specific wavelength range, a method of using the principle of photonic crystal or a metamaterial or a metasurface formed by artificially preparing a periodic structure having a period of a wavelength or less is known. However, in order to form this structure, a process such as crystal growth of a semiconductor material or photolithography/electron beam lithography is required in many cases, and thus the method is not suitable for an increase in area. Further the manufacturing cost also increases.

In addition, recently, the use of selective absorption of plasmon resonance of inorganic nanoparticles synthesized using a chemical method has been investigated. In general, in this material system, a plasmon resonance wavelength is predetermined depending on the composition of synthesized particles, and it is difficult to perform a control of adjusting the plasmon resonance wavelength to a desired resonance wavelength range, a control of exhibiting resonance absorption as necessary, or the like.

On the other hand, G Garcia et al., “Dynamically Modulating the Surface Plasmon Resonance of Doped Semiconductor Nanocrystals”, Nanoletters Vol. 11 pp. 4415-4420 (2011) reports that an electric field is applied to an Sn-doped indium oxide nanocrystal film in an electrolytic solution such that a plasmon resonance wavelength of the crystal film can be dynamically controlled.

### SUMMARY OF THE INVENTION

In the invention described in G Garcia et al., “Dynamically Modulating the Surface Plasmon Resonance of Doped Semiconductor Nanocrystals”, Nanoletters Vol. 11 pp. 4415-4420 (2011), the electrolytic solution is required, and the application thereof to devices is difficult.

Accordingly, an object of the present invention is to provide a new optical modulation element that can dynamically change selective absorption of light. Accordingly, another object of the present invention is to provide a new optical shutter and a new optical modulation method.

The present inventors conducted a thorough investigation on inorganic nanoparticles that exhibits localized surface plasmon resonance by light irradiation, and found that, by providing a dielectric layer between an electrode layer and a layer of inorganic nanoparticles that exhibits localized surface plasmon resonance by light irradiation and applying a voltage to the layer of the inorganic nanoparticles, resonance absorption of the inorganic nanoparticles can be changed, thereby completing the present invention. Accordingly, the present invention provides the following.

<1> An optical modulation element comprising:
a substrate;
an electrode layer provided on the substrate;
a dielectric layer provided on the electrode layer; and
a light absorbing layer provided on the dielectric layer and including inorganic nanoparticles,
in which the inorganic nanoparticles exhibit localized surface plasmon resonance by light irradiation.

<2> The optical modulation element according to <1>, further comprising:
a second electrode layer provided on the light absorbing layer.

<3> The optical modulation element according to <2>,
in which the second electrode layer is an oxide semiconductor.

<4> The optical modulation element according to <2> or <3>,
in which the second electrode layer includes tin-doped indium oxide.

<5> The optical modulation element according to any one of <1> to <4>,
in which the inorganic nanoparticles are particles of a semiconductor.

<6> The optical modulation element according to <5>,
in which the semiconductor is an oxide semiconductor.

<7> The optical modulation element according to <6>,
in which the oxide semiconductor includes at least one atom selected from indium, zinc, tin, or cerium.

<8> The optical modulation element according to any one of <1> to <7>,
in which the inorganic nanoparticles include tin-doped indium oxide particles.

<9> The optical modulation element according to any one of <1> to <8>,
in which an average particle diameter of the inorganic nanoparticles is 1 to 100 nm.

<10> The optical modulation element according to any one of <1> to <9>,
in which a ligand is coordinated to the inorganic nanoparticles.

<11> The optical modulation element according to <10>,
in which the ligand includes at least one selected from a ligand including a halogen atom or a multidentate ligand including two or more coordination sites.

<12> The optical modulation element according to any one of <1> to <11>,
in which reflected light or transmitted light of light incident into the optical modulation element is dynamically modulated by changing a voltage to be applied to the light absorbing layer.

<13> An optical shutter comprising:
the optical modulation element according to any one of <1> to <12>.

<14> An optical modulation method comprising:
dynamically modulating reflected light or transmitted light of light incident into the optical modulation element according to any one of <1> to <12> by changing a voltage to be applied to the light absorbing layer of the optical modulation element.

According to the present invention, a new optical modulation element that can dynamically change selective absorption of light can be provided. In addition, according to the present invention, a new optical shutter and a new optical modulation method can be provided.

### BRIEF DESCRIPTION OF THE DRAWINGS

FIG. 1 is a diagram showing a first embodiment of an optical modulation element.

FIG. 2 is a diagram showing a second embodiment of the optical modulation element.

### DESCRIPTION OF THE PREFERRED EMBODIMENTS

Hereinafter, the details of the present invention will be described.

In the present specification, numerical ranges represented by “to” include numerical values before and after “to” as lower limit values and upper limit values.

In the present specification, unless specified as a substituted group or as an unsubstituted group, a group (atomic group) denotes not only a group (atomic group) having no substituent but also a group (atomic group) having a substituent. For example, “alkyl group” denotes not only an alkyl group having no substituent (unsubstituted alkyl group) but also an alkyl group having a substituent (substituted alkyl group).

<Optical Modulation Element>

An optical modulation element according to an embodiment of the present invention comprises:
a substrate;
an electrode layer provided on the substrate;
a dielectric layer provided on the electrode layer; and
a light absorbing layer provided on the dielectric layer and including inorganic nanoparticles,
in which the inorganic nanoparticles exhibit localized surface plasmon resonance by light irradiation.

In the optical modulation element according to the embodiment of the present invention, by applying a voltage to the light absorbing layer, a position of a plasmon resonance wavelength or an absorbance at the plasmon resonance wavelength in the localized surface plasmon resonance of the inorganic nanoparticles is changed such that selective absorption of light in the light absorbing layer can be dynamically changed. Therefore, the reflected light or the transmitted light of the light incident into the optical modulation element can be dynamically modulated depending on the applied voltage. The detailed reason why such an effect is obtained is unknown, but it is presumed as follows. A plasmon resonance wavelength of the inorganic nanoparticles is presumed to depend on a carrier concentration. The reason for this is presumed to be that, by applying the voltage to the light absorbing layer including the inorganic nanoparticles, charge transfer or accumulation or depletion of carriers in the light absorbing layer occurs or a carrier concentration distribution in the light absorbing layer changes.

Here, the localized surface plasmon resonance refers to a resonance phenomenon in which a collective oscillation phenomenon of electrons occurs on particle surfaces at a specific wavelength of light such that strong absorption of light (resonance absorption) occurs. Accordingly, the light absorbing layer exhibits strong absorption at the wavelength (plasmon resonance wavelength) at which the localized surface plasmon resonance of the inorganic nanoparticles occurs. Whether or not the inorganic nanoparticles exhibit localized surface plasmon resonance by light irradiation can be determined by measuring whether or not an electric field enhancement is shown in a wavelength range where strong resonance absorption occurs using tip-enhanced Raman scattering or an analysis apparatus including a scanning near field probe such as a scanning near field optical microscope. In addition, it is also effective to inspect or measure, after clarifying an element or a compound forming particles, whether or not a bulk body of the element or the compound has light absorption in a specific wavelength range. In a case where the bulk body of the material forming the particles originally does not have absorption in the wavelength range, it can be determined that the absorption occurred in the specific wavelength range is the localized surface plasmon absorption.

In addition, in the present specification, examples of an aspect of modulating light include an aspect of changing an intensity of light (for example, an intensity of light at a specific wavelength), an aspect of changing a spectrum of light, an aspect of changing a traveling direction of light, and an aspect of changing deflection of light. Among these, the aspect of changing an intensity of light or the aspect of changing a spectrum of light is preferable.

The optical modulation element according to the embodiment of the present invention may be a reflective optical modulation element that modulates reflected light of light incident into the optical modulation element or may be a transmissive optical modulation element that modulates light (transmitted light) transmitted through the optical modulation element. In addition, the optical modulation element according to the embodiment of the present invention may be used after irradiation of light from the substrate side or may be used after irradiation of light from a surface opposite to the substrate.

A specific resistance value of the light absorbing layer in the optical modulation element according to the embodiment of the present invention may be high. However, from the viewpoint that the selective absorption of light in the light absorbing layer can be changed more significantly by the voltage application, it is preferable that the specific resistance value of the light absorbing layer is low. The specific resistance value of the light absorbing layer is preferably 10⁵ Ωcm or less, more preferably 10³ Ωcm or less, and still more preferably 10¹ Ωcm or less.

In the optical modulation element according to the embodiment of the present invention, an electrode layer (second electrode layer) may be provided on the light absorbing layer. Even in this aspect, the selective absorption of light in the light absorbing layer can be changed more significantly by the voltage application.

The optical modulation element according to the embodiment of the present invention can be used for an optical shutter, a molecular sensor, an optical sensor, a heat radiation apparatus, a radiative cooling apparatus, or the like. In addition, the optical shutter can be used for, for example, various apparatuses such as an optical sensor (an image sensor, laser imaging detection and ranging (Lidar), or the like), thermography, or a heat shielding apparatus.

Hereinafter, the optical modulation element according to the embodiment of the present invention will be described using the drawings.

### First Embodiment

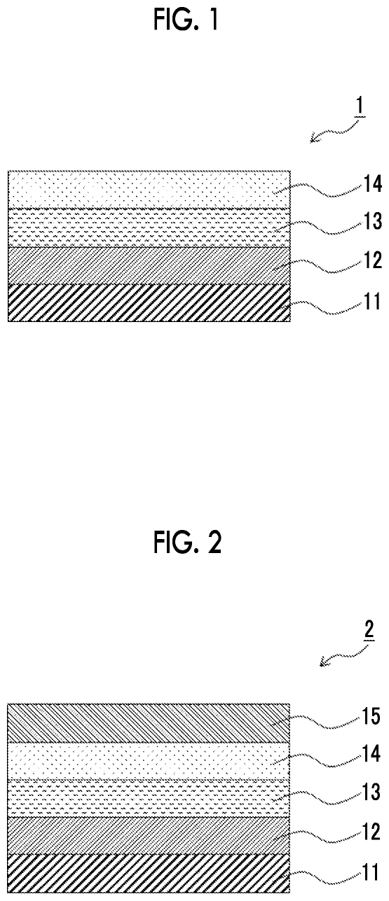

FIG. 1 is a diagram showing a first embodiment of the optical modulation element according to the embodiment of the present invention. The optical modulation element 1 includes: a substrate 11; a first electrode layer 12 provided on the substrate 11; a dielectric layer 13 provided on the first electrode layer 12; and a light absorbing layer 14 provided on the dielectric layer 13. The optical modulation element 1 can be used by applying a voltage between the first electrode layer 12 and the light absorbing layer 14.

The kind of the substrate 11 is not particularly limited. Examples of the substrate 11 include a glass substrate, a quartz substrate, a synthetic quartz substrate, a resin substrate, a ceramic substrate, a silicon substrate, and the other semiconductor substrates.

In a case where the optical modulation element according to the embodiment of the present invention is a transmissive optical modulation element or in a case where the optical modulation element according to the embodiment of the present invention is used after irradiation from the substrate 11 side, It is preferable that the substrate 11 is substantially transparent with respect to a wavelength of desired light to modulated by the optical modulation element. In the present specification, “substantially transparent” represents that the light transmittance is 50% or more, preferably 60% or more, and more preferably 80% or more.

The thickness of the substrate 11 is not particularly limited and is preferably 1 to 2000 μm, more preferably 5 μm to 1000 μm, and still more preferably 50 μm to 1000 μm.

As shown in FIG. 1, the first electrode layer 12 is provided on the substrate 11. It is preferable that the first electrode layer 12 is formed of a material (electrode material) including at least one atom selected from gold (Au), platinum (Pt), iridium (Jr), palladium (Pd), copper (Cu), lead (Pb), titanium (Ti), strontium (Sr), tungsten (W), molybdenum (Mo), tantalum (Ta), germanium (Ge), nickel (Ni), chromium (Cr), indium (In), zinc (Zn), tin (Sn), or cerium (Ce). The electrode material may be single metal, may be an alloy, or may be a compound including the above-described atom.

In addition, the first electrode layer 12 may be formed of an oxide semiconductor. Examples of the oxide semiconductor include tin oxide, zinc oxide, indium oxide, indium zinc oxide, tin (Sn)-doped indium oxide (indium tin oxide; ITO), tungsten (W)-doped indium oxide, antimony (Sb)-doped tin oxide (antimony doped tin oxide; ATO), yttrium (Y)-doped strontium titanate, fluorine-doped tin oxide (FTO), aluminum (Al)-doped zinc oxide, gallium (Ga)-doped zinc oxide, niobium (Nb)-doped titanium oxide, and indium tungsten oxide.

From the viewpoint of adhesiveness with the dielectric layer 13 and the like, it is more preferable that the first electrode layer 12 is formed of a material including at least one selected from Mo, Jr, Ti, Cr, Ge, W, Ta, or Ni.

In addition, in a case where the dielectric layer 13 is silicon oxide (SiO₂) or hafnium oxide (HfO₂), it is preferable that the first electrode layer 12 is formed of a material including at least one atom selected from Mo, Ti, or Cr.

The first electrode layer 12 may be a single-layer film or a laminated film including two or more layers.

In a case where the optical modulation element is a transmissive optical modulation element or in a case where the optical modulation element is used after irradiation from the substrate 11 side, it is preferable that the first electrode layer 12 is substantially transparent with respect to a wavelength of desired light to modulated by the optical modulation element.

For example, the first electrode layer 12 can be formed using a vacuum deposition method such as ion plating or ion beam, a physical vapor deposition method (PVD method) such as sputtering, a chemical vapor deposition method (CVD method), or a spin coating method.

The film thickness of the first electrode layer 12 is preferably 1 to 1000 nm, more preferably 10 to 500 nm, and still more preferably 50 to 300 nm. In the present invention, the film thickness of each of the layers can be measured by observing a cross section of the optical modulation element using a scanning electron microscope (SEM) or the like.

As shown in FIG. 1, the dielectric layer 13 is provided on the first electrode layer 12. Examples of a material forming the dielectric layer 13 include silicon oxide (SiO₂), silicon nitride (Si₃N₄), silicon oxynitride (SiON), magnesium fluoride (MgF₂), sodium aluminum fluoride (Na₃AlF₆), aluminum oxide (Al₂O₃), yttrium oxide (Y₂O₃), tantalum oxide (Ta₂O₅), hafnium oxide (HfO₂), zirconium oxide (ZrO₂), and a material including two or more of the above-described materials.

A relative permittivity of the dielectric layer 13 is preferably 1 to 100, more preferably 1 to 50, and still more preferably 1 to 20. The relative permittivity refers to a ratio between a dielectric constant of a thing and a dielectric constant of a vacuum. The relative permittivity is a dimensionless quantity.

In a case where the optical modulation element according to the embodiment of the present invention is a transmissive optical modulation element or in a case where the optical modulation element according to the embodiment of the present invention is used after irradiation from the substrate 11 side, it is preferable that the dielectric layer 13 is substantially transparent with respect to a wavelength of desired light to modulated by the optical modulation element.

It is desirable that the dielectric layer 13 is an insulator having a high electric resistance. Here, the insulator refers to a material having a specific resistance of higher than 10⁹ Ωcm. For example, the dielectric layer 13 can be formed using a vacuum deposition method such as ion plating or ion beam, a physical vapor deposition method (PVD method) such as sputtering, a chemical vapor deposition method (CVD method), or a spin coating method.

The film thickness of the dielectric layer 13 is preferably 1 to 2000 nm, more preferably 10 to 1000 nm, and still more preferably 50 to 500 nm. In a case where the film thickness of the dielectric layer 13 is in the above-described range, the selective absorption of light in the light absorbing layer 14 can be changed more significantly by the voltage application.

As shown in FIG. 1, the light absorbing layer 14 is provided on the dielectric layer 13. The light absorbing layer 14 includes inorganic nanoparticles that exhibits localized surface plasmon resonance by light irradiation.

An average particle diameter of the inorganic nanoparticles is preferably 1 to 100 nm. A lower limit value of the average particle diameter of the inorganic nanoparticles is preferably 5 nm or more and more preferably 10 nm or more. In addition, an upper limit value of the average particle diameter of the inorganic nanoparticles is preferably 70 nm or less and more preferably 50 nm or less. In the present specification, the value of the average particle diameter of the inorganic nanoparticles is an average value of particle diameters of ten freely selected inorganic nanoparticles. For the measurement of the particle diameters of the inorganic nanoparticles, a transmission electron microscope may be used.

It is preferable that the plasmon resonance wavelength of the inorganic nanoparticles is present in a wavelength range of 1 to 20 μm, and it is more preferable that the plasmon resonance wavelength of the inorganic nanoparticles is present in a wavelength range of 1.2 to 15 μm. Regarding the film of the inorganic nanoparticles, the plasmon resonance wavelength can be measured by calculating a spectral reflectance using a Fourier transform infrared spectrophotometer (FTIR) or a spectrophotometer and calculating a maximum point of the spectral reflectance.

A half-width of a peak value of an absorbance at the plasmon resonance wavelength of the inorganic nanoparticles is not particularly limited. In a case where the half-width is narrow, stronger absorption can be obtained or stronger electric field enhancement can be obtained at a specific wavelength. In this case, the half-width is preferably 3 μm or less and more preferably 2 μm or less. In addition, in a case where the half-width is wide, for example, in a system where a light source including light having a wide wavelength is present, all the light components other than a target wavelength can be shielded or modulated. In this case, the half-width is preferably more than 3 μm and more preferably 4 μm or more.

It is preferable that the inorganic nanoparticles are formed of a material including at least one atom selected from gold (Au), silver (Ag), bismuth (Bi), platinum (Pt), iridium (Jr), palladium (Pd), copper (Cu), lead (Pb), titanium (Ti), strontium (Sr), tungsten (W), molybdenum (Mo), tantalum (Ta), germanium (Ge), nickel (Ni), chromium (Cr), indium (In), zinc (Zn), tin (Sn), or cerium (Ce).

The inorganic nanoparticles may be metal particles. However, since the free electron concentration is less than metal and the plasmon resonance is likely to be dynamically modulated, it is preferable that the inorganic parties are particles of a semiconductor. Examples of the semiconductor forming the inorganic nanoparticles include semiconductors including at least one atom selected from silver (Ag), bismuth (Bi), lead (Pb), titanium (Ti), strontium (Sr), germanium (Ge), silicon (Si), indium (In), zinc (Zn), tin (Sn), cerium (Ce), gallium (Ga), aluminum (Al), copper (Cu), tungsten (W), or niobium (Nb).

Examples of a preferable aspect of the semiconductor include an oxide semiconductor. It is preferable that the oxide semiconductor is an oxide semiconductor including at least one atom selected from indium (In), zinc (Zn), tin (Sn), tungsten (W), or cerium (Ce). Specific examples of the oxide semiconductor include tin oxide, zinc oxide, indium oxide, indium zinc oxide, tin (Sn)-doped indium oxide (indium tin oxide; ITO), tungsten (W)-doped indium oxide, antimony (Sb)-doped tin oxide (antimony doped tin oxide; ATO), cerium (Ce)-doped indium oxide, yttrium (Y)-doped strontium titanate, fluorine-doped tin oxide (FTO), aluminum (Al)-doped zinc oxide, gallium (Ga)-doped zinc oxide, niobium (Nb)-doped titanium oxide, indium tungsten oxide, tungsten oxide, and indium zinc oxide. Tin (Sn)-doped indium oxide, aluminum (Al)-doped zinc oxide, gallium (Ga)-doped zinc oxide, or cerium (Ce)-doped indium oxide is preferable, and from the viewpoint that the resonance wavelength in a wide wavelength range corresponding to the doping amount of tin (Sn) can be controlled, tin (Sn)-doped indium oxide is more preferable.

In addition, the doping amount of tin (Sn) in the tin (Sn)-doped indium oxide is preferably 0.1 to 15 at % and more preferably 0.2 to 10 at %.

In addition, as the inorganic nanoparticles, particles of PbS, PbSe, PbSeS, InN, InAs, Ge, InAs, InGaAs, CuInS, CuInSe, CuInGaSe, InSb, HgTe, HgCdTe, Ag₂S, Ag₂Se, Ag₂Te, SnS, SnSe, SnTe, Si, InP, Cu₂S, and the like can also be used.

The specific resistance value of the light absorbing layer 14 is preferably 10⁵ Ωcm or less, more preferably 10³ Ωcm or less, and still more preferably 10¹ Ωcm or less.

It is preferable that the light absorbing layer 14 includes a ligand coordinated to the inorganic nanoparticles. By including the ligand, isolation between the particles is improved, and strong absorption properties by plasmon resonance are further improved. Examples of the ligand include a long-chain ligand, a ligand including a halogen atom, and a multidentate ligand including two or more coordination sites. Among these, a ligand including a halogen atom or a multidentate ligand including two or more coordination sites is preferable. The light absorbing layer 14 may include only one ligand or may contain two or more ligands.

From the viewpoint of ensuring the dispersibility of particles, the long-chain ligand is preferably a ligand that has a molecular chain having 6 or more carbon atoms and more preferably a ligand that has a molecular chain having 10 or more carbon atoms. The long-chain ligand may be a saturated compound or an unsaturated compound. The long-chain ligand is preferably a monodentate ligand. Examples of the long-chain ligand include a saturated fatty acid having 6 or more carbon atoms, an unsaturated fatty acid having 6 or more carbon atoms, an aliphatic amine compound having 6 or more carbon atoms, an aliphatic thiol compound having 6 or more carbon atoms, and an organic phosphorus compound having 6 or more carbon atoms. Specific examples of the ligand include decanoic acid, lauric acid, myristic acid, palmitic acid, stearic acid, behenic acid, oleic acid, erucic acid, oleyl amine, dodecyl amine, dodecanethiol, hexadecanethiol, trioctylphosphine oxide, and cetrimonium bromide.

Next, the ligand including a halogen atom will be described. Examples of the halogen atom contained in the ligand include a fluorine atom, a chlorine atom, a bromine atom, and an iodine atom, and an iodine atom is preferable from the viewpoint of coordinating power to the inorganic nanoparticles.

The ligand including a halogen atom may be an organic halide or may be an inorganic halide. In addition, the inorganic halide is preferably a compound including an atom selected from a zinc (Zn) atom, an indium (In) atom, or a cadmium (Cd) atom and more preferably a compound including a Zn atom. The inorganic halide is preferably a salt of a metal atom and a halogen atom from the viewpoint that the salt is easily ionized and easily coordinated to the inorganic nanoparticles.

Specific examples of the ligand including a halogen atom include zinc iodide, zinc bromide, zinc chloride, indium iodide, indium bromide, indium chloride, cadmium iodide, cadmium bromide, and cadmium chloride, gallium iodide, gallium bromide, gallium chloride, tetrabutylammonium iodide, and tetramethylammonium iodide.

In the ligand including a halogen atom, the halogen ion may be dissociated from the ligand described above and coordinated to the surfaces of the inorganic nanoparticles. In addition, a site of the ligand other than the halogen atom described above may also be coordinated to the surfaces of the inorganic nanoparticles. A specific example will be described. In the case of zinc iodide, zinc iodide may be coordinated to the surfaces of the inorganic nanoparticles, or the iodine ion or the zinc ion may be coordinated to the surfaces of the inorganic nanoparticles.

Next, the multidentate ligand will be described. Examples of the coordination site in the multidentate ligand include a thiol group, an amino group, a hydroxy group, a carboxy group, a sulfo group, a phospho group, and a phosphonate group.

Examples of the multidentate ligand include a ligand represented by any of Formulae (A) to (C).

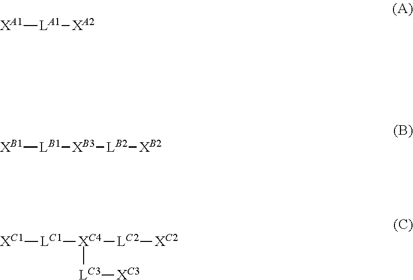

In Formula (A), X^{A1} and X^{A2} each independently represent a thiol group, an amino group, a hydroxy group, a carboxy group, a sulfo group, a phospho group, or a phosphonate group.

L^{A1} represents a hydrocarbon group.

In Formula (B), X^{B1} and X^{B2} each independently represent a thiol group, an amino group, a hydroxy group, a carboxy group, a sulfo group, a phospho group, or a phosphonate group.

X^{B3} represents S, O, or NH.

L^{B1} and L^{B2} each independently represent a hydrocarbon group.

In Formula (C), X^{C1} to X^{C3} each independently represent a thiol group, an amino group, a hydroxy group, a carboxy group, a sulfo group, a phospho group, or a phosphonate group.

X^{C4} represents N.

L^{C1} to L^{C3} each independently represent a hydrocarbon group.

The amino group represented by X^{A1}, X^{A2}, X^{B1}, X^{B2}, X^{C1}, X^{C2}, or X^{C3} is not limited to —NH₂ and also includes a substituted amino group and a cyclic amino group. Examples of the substituted amino group include a monoalkylamino group, a dialkylamino group, a monoarylamino group, a diarylamino group, and an alkylarylamino group. The amino group is preferably —NH₂, a monoalkylamino group, or a dialkylamino group, and more preferably —NH₂.

The hydrocarbon group represented by L^{A1}, L^{B1}, L^{B2}, L^{C1}, L^{C2}, or L^{C3} is preferably an aliphatic hydrocarbon group or a group including an aromatic ring and more preferably an aliphatic hydrocarbon group. The aliphatic hydrocarbon group may be a saturated aliphatic hydrocarbon group or may be an unsaturated aliphatic hydrocarbon group. The number of carbon atoms in the hydrocarbon group is preferably 1 to 20. The upper limit of the number of carbon atoms is preferably 10 or less, more preferably 6 or less, and still more preferably 3 or less. Specific examples of the hydrocarbon group include an alkylene group, an alkenylene group, an alkynylene group, and an arylene group.

Examples of the alkylene group include a linear alkylene group, a branched alkylene group, and a cyclic alkylene group. A linear alkylene group or a branched alkylene group is preferable, and a linear alkylene group is more preferable. Examples of the alkenylene group include a linear alkenylene group, a branched alkenylene group, and a cyclic alkenylene group. A linear alkenylene group or a branched alkenylene group is preferable, and a linear alkenylene group is more preferable. Examples of the alkynylene group include a linear alkynylene group and a branched alkynylene group, and a linear alkynylene group is preferable. The arylene group may be a monocycle or a polycycle. The monocyclic arylene group is preferable. Specific examples of the arylene group include a phenylene group and a naphthylene group. Among these, a phenylene group is preferable. The alkylene group, the alkenylene group, the alkynylene group, and the arylene group may further have a substituent. The substituent is preferably a group having 1 or more and 10 or less of atoms. Specific preferable examples of the group having 1 or more and 10 or less of atoms include an alkyl group having 1 to 3 carbon atoms [a methyl group, an ethyl group, a propyl group, or an isopropyl group], an alkenyl group having 2 or 3 carbon atoms [an ethenyl group or a propenyl group], an alkynyl group having 2 to 4 carbon atoms [an ethynyl group, a propynyl group, or the like], a cyclopropyl group, an alkoxy group having 1 or 2 carbon atoms [a methoxy group or an ethoxy group], an acyl group having 2 or 3 carbon atoms [an acetyl group or a propionyl group], an alkoxycarbonyl group having 2 or 3 carbon atoms [a methoxycarbonyl group or an ethoxycarbonyl group], an acyloxy group having 2 carbon atoms [an acetyloxy group], an acylamino group having 2 carbon atoms [an acetylamino group], a hydroxyalkyl group having 1 to 3 carbon atoms [a hydroxymethyl group, a hydroxyethyl group, or a hydroxypropyl group], an aldehyde group, a hydroxy group, a carboxy group, a sulfo group, a phospho group, a carbamoyl group, a cyano group, an isocyanate group, a thiol group, a nitro group, a nitroxy group, an isothiocyanate group, a cyanate group, a thiocyanate group, an acetoxy group, an acetamide group, a formyl group, a formyloxy group, a formamide group, a sulfamino group, a sulfino group, a sulfamoyl group, a phosphono group, an acetyl group, a halogen atom, and an alkali metal atom.

In Formula (A), X^{A1} and X^{A2} are separated by L^{A1} preferably by 1 to 10 atoms, more preferably by 1 to 6 atoms, still more preferably by 1 to 4 atoms, still more preferably by 1 to 3 atoms, and still more preferably by 1 or 2 atoms.

In Formula (B), X^{B1} and X^{B3} are separated by L^{B1} preferably by 1 to 10 atoms, more preferably by 1 to 6 atoms, more preferably by 1 to 4 atoms, still more preferably by 1 to 3 atoms, and still more preferably by 1 or 2 atoms. In addition, X^{B2} and X^{B3} are separated by L^{B2} preferably by 1 to 10 atoms, more preferably by 1 to 6 atoms, still more preferably by 1 to 4 atoms, still more preferably by 1 to 3 atoms separated, and still more preferably by 1 or 2 atoms.

In Formula (C), X^{C1} and X^{C4} are separated by L^{C1} preferably by 1 to 10 atoms, more preferably by 1 to 6 atoms, more preferably by 1 to 4 atoms, still more preferably by 1 to 3 atoms, and still more preferably by 1 or 2 atoms. In addition, X^{C2} and X^{C4} are separated by L^{C2} preferably by 1 to 10 atoms, more preferably by 1 to 6 atoms, still more preferably by 1 to 4 atoms, still more preferably by 1 to 3 atoms separated, and still more preferably by 1 or 2 atoms. In addition, X^{C3} and X^{C4} are separated by L^{C3} preferably by 1 to 10 atoms, more preferably by 1 to 6 atoms, still more preferably by 1 to 4 atoms, still more preferably by 1 to 3 atoms separated, and still more preferably by 1 or 2 atoms.

X^{A1} and X^{A2} being separated by L^{A1} by 1 to 10 atoms represents that the number of atoms forming a molecular chain that connects X^{A1} and X^{A2} by the shortest distance is 1 to 10. For example, in the following Formula (A1), X^{A1} and X^{A2} are separated by 2 atoms, and in the following Formulae (A2) and (A3), X^{A1} and X^{A2} are separated by 3 atoms. The numbers added to the following structural formulae represent the arrangement order of atoms forming a molecular chain that connects X^{A1} and X^{A2} by the shortest distance.

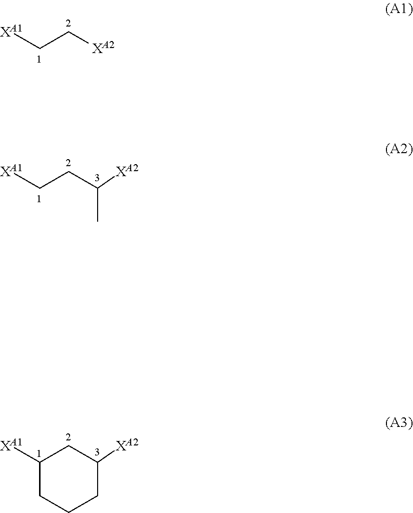

The description will be made using a specific compound as an example. 3-mercaptopropionic acid is a compound having a structure in which a site corresponding to X^{A1} is a carboxy group, a site corresponding to X^{A2} is a thiol group, and a site corresponding to L^{A1} is an ethylene group (a compound having the following structure). In the 3-mercaptopropionic acid, X^{A1} (carboxy group) and X^{A2} (thiol group) are separated by L^{A1} (ethylene group) by two atoms.

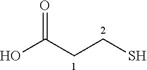

The same can be applied to X^{B1} and X^{B3} being separated by L^{B1} by 1 to 10 atoms, X^{B2} and X^{B3} being separated by L^{B2} by 1 to 10 atoms, X^{C1} and X^{C4} being separated by L^{C1} by 1 to 10 atoms, X^{C2} and X^{C4} being separated by L^{C2} by 1 to 10 atoms, and X^{C3} and X^{C4} being separated by L^{C3} by 1 to 10 atoms.

Specific examples of the multidentate ligand include 3-mercaptopropionic acid, thioglycolic acid, 2-aminoethanol, 2-aminoethanediol, 2-mercaptoethanol, glycolic acid, ethylene glycol, ethylenediamine, aminosulfonic acid, glycine, aminomethylphosphoric acid, guanidine, diethylenetriamine, tris(2-aminoethyl)amine, 4-mercaptobutanoic acid, 3-aminopropanol, 3-mercaptopropanol, N-(3-aminopropyl)-1,3-propanediamine, 3-(bis(3-aminopropyl)amino)propan-1-ol,1-thioglycerol, dimercaprol, 1-mercapto-2-butanol, 1-mercapto-2-pentanol, 3-mercapto-1-propanol, 2,3-dimercapto-1-propanol, diethanolamine, 2-(2-aminoethyl)aminoethanol, dimethylenetriamine, 1,1-oxybismethylamine, 1,1-thiobismethylamine, 2-[(2-aminoethyl)amino]ethanethiol, bis(2-mercaptoethyl)amine, 2-aminoethane-1-thiol, 1-amino-2-butanol, 1-amino-2-pentanol, L-cysteine, D-cysteine, 3-amino-1-propanol, L-homoserine, D-homoserine, aminohydroxyacetic acid, L-lactic acid, D-lactic acid, L-malic acid, D-malic acid, glyceric acid, 2-hydroxybutyric acid, L-tartaric acid, D-tartrate acid, tartronic acid, 1,2-benzenedithiol, 1,3-benzenedithiol, 1,4-benzenedithiol, 2-mercaptobenzoic acid, 3-mercaptobenzoic acid, 4-mercaptobenzoic acid, and derivatives thereof.

The film thickness of the light absorbing layer 14 is preferably 5 to 1000 nm, more preferably 20 to 500 nm, and still more preferably 50 to 300 nm. In a case where the film thickness of the light absorbing layer 14 is in the above-described range, the selective absorption of light in the light absorbing layer 14 can be changed more significantly by the voltage application.

The light absorbing layer 14 can be formed through a step of applying a dispersion liquid including the inorganic nanoparticles to the dielectric layer 13. The dispersion liquid includes the ligand coordinated to the inorganic nanoparticles. From the viewpoint of the dispersibility of the inorganic nanoparticles in the dispersion liquid, it is preferable that a long-chain ligand is coordinated to the inorganic nanoparticles. Examples of the long-chain ligand are as described above.

A method of applying the dispersion liquid is not particularly limited. Examples of the method include coating methods such as a spin coating method, a dipping method, an ink jet method, a dispenser method, a screen printing method, a relief printing method, an intaglio printing method, and a spray coating method.

After applying the dispersion liquid to the dielectric layer 13 to form a coating film, a ligand exchange process may be further performed to exchange the ligand coordinated to the inorganic nanoparticles with another ligand. In the ligand exchange process, a ligand solution including a ligand (hereinafter, also referred to as a ligand A) different from the ligand in the above-described dispersion liquid and including a solvent is applied to the coating film to exchange the ligand coordinated to the inorganic nanoparticles with the ligand A in the ligand solution. The formation of the coating film and the ligand exchange process may be alternately repeated multiple times.

Examples of the ligand A include a ligand including a halogen atom, and a multidentate ligand including two or more coordination sites. The details of the ligand A are, for example, as described above, and a preferable range is also the same.

The ligand solution used in the ligand exchange process may include only one ligand A or may include two or more ligands A. In addition, two or more ligand solutions including different ligands A may be used.

It is preferable that the solvent in the ligand solution is appropriately selected depending on the kind of the ligand in each of ligand solutions, and it is preferable that the solvent is a solvent in which each of the ligands is easily soluble. In addition, the solvent in the ligand solution is preferably an organic solvent having a high dielectric constant. Specific examples of the solvent include ethanol, acetone, methanol, acetonitrile, dimethylformamide, dimethyl sulfoxide, butanol, and propanol. In addition, the solvent in the ligand solution is preferably a solvent that is not likely to remain in the formed light absorbing layer. From the viewpoints of easy drying and easy removal by washing, a low boiling point alcohol, a ketone, or a nitrile is preferable, and methanol, ethanol, acetone, or acetonitrile is more preferable. It is preferable that the solvent in the ligand solution is not mixed with the solvent in the dispersion liquid. As a preferable combination of the solvents, in a case where the solvent in the dispersion liquid is an alkane such as hexane or octane or toluene, it is preferable that the solvent in the ligand solution is a polar solvent such as methanol or acetone.

A method of applying the ligand solution to the coating film is not particularly limited, and a coating method such as a spin coating method, a dipping method, an ink jet method, a dispenser method, a screen printing method, a relief printing method, an intaglio printing method, or a spray coating method can be used.

During the formation of the light absorbing layer 14, the film after the ligand exchange process may come into contact with a rinsing liquid to perform a rinsing treatment. By performing the rinsing treatment, an excess amount of the ligand in the film or the ligand released from the inorganic nanoparticles can be removed. In addition, the remaining solvent and other impurities can be removed. The rinsing liquid is preferably an aprotic solvent from the viewpoint that an excess amount of the ligand in the film or the ligand released from the inorganic nanoparticles is likely to be removed more effectively and the film surface is likely to be uniformly maintained by rearranging the inorganic nanoparticle surfaces. Specific examples of the aprotic solvent include acetonitrile, acetone, methyl ethyl ketone, methyl isobutyl ketone, cyclopentanone, diethyl ether, tetrahydrofuran, cyclopentyl methyl ether, dioxane, ethyl acetate, butyl acetate, propylene glycol monomethyl ether acetate, hexane, octane, cyclohexane, benzene, toluene, chloroform, carbon tetrachloride, and dimethylformamide. Among these, acetonitrile or tetrahydrofuran is preferable, and acetonitrile is more preferable.

In addition, the rinsing treatment may be performed multiple times using two or more rinsing liquids having different polarities (relative permittivity). For example, it is preferable that, after performing rinsing using a rinsing liquid (also referred to as a first rinsing liquid) having a high relative permittivity, rinsing is performed using a rinsing liquid (also referred to as a second rinsing liquid) having a lower relative permittivity than the first rinsing liquid. By performing rinsing as described above such that the surplus component of the ligand A used for the ligand exchange is removed first and subsequently the ligand component (component originally coordinated to the particles) released in the process of the ligand exchange is removed, both of the surplus ligand component and the released ligand component can be more efficiently removed.

The relative permittivity of the first rinsing liquid is preferably 15 to 50, more preferably 20 to 45, and still more preferably 25 to 40. The relative permittivity of the second rinsing liquid is preferably 1 to 15, more preferably 1 to 10, and still more preferably 1 to 5.

During the formation of the light absorbing layer 14, a drying treatment may be further performed. The drying time is preferably 1 to 100 hours, more preferably 1 to 50 hours, and still more preferably 5 to 30 hours. The drying temperature is preferably 10° C. to 100° C., more preferably 20° C. to 90° C., and still more preferably 20° C. to 50° C.

Although not shown in the drawing, in the optical modulation element 1, a protective layer may be provided on the light absorbing layer 14. Examples of a material of the protective layer include the above-described dielectric material, a metal oxide, an oxide semiconductor, an organic semiconductor, and a polymer. In addition, although not shown in the drawing, a terminal for applying a voltage may be provided in the first electrode layer 12 and the light absorbing layer 14. In addition, in a case where the optical modulation element 1 is used as a reflective optical modulation element, a light reflecting member may be provided on a side of the optical modulation element 1 opposite to an incidence side. For example, in a case where the light absorbing layer 14 side is the light incidence side, the light reflecting member may be provided on the substrate 11 side of the optical modulation element 1.

### Second Embodiment

FIG. 2 is a diagram showing a second embodiment of the optical modulation element according to the present invention. The optical modulation element 2 has the same configuration as the optical modulation element according to the first embodiment, except that a second electrode layer 15 is further provided on the light absorbing layer 14. The optical modulation element 2 can be used by applying a voltage between the first electrode layer 12 and the second electrode layer 15.

In a case where the optical modulation element is a transmissive optical modulation element or in a case where the optical modulation element is used after irradiation from the second electrode layer 15 side, it is preferable that the second electrode layer 15 is substantially transparent with respect to a wavelength of desired light to modulated by the optical modulation element 2.

It is preferable that the second electrode layer 15 is formed of a material (electrode material) including at least one atom selected from gold (Au), platinum (Pt), iridium (Jr), palladium (Pd), copper (Cu), lead (Pb), titanium (Ti), strontium (Sr), tungsten (W), molybdenum (Mo), tantalum (Ta), germanium (Ge), nickel (Ni), chromium (Cr), indium (In), zinc (Zn), tin (Sn), or cerium (Ce). The electrode material may be single metal, may be an alloy, or may be a compound including the above-described atom. In addition, the second electrode layer 15 may be formed of an oxide semiconductor. Examples of the oxide semiconductor include tin oxide, zinc oxide, indium oxide, indium zinc oxide, tin (Sn)-doped indium oxide (indium tin oxide; ITO), tungsten (W)-doped indium oxide, antimony (Sb)-doped tin oxide (antimony doped tin oxide; ATO), yttrium (Y)-doped strontium titanate, fluorine-doped tin oxide (FTO), aluminum (Al)-doped zinc oxide, gallium (Ga)-doped zinc oxide, niobium (Nb)-doped titanium oxide, and indium tungsten oxide. From the viewpoint that the effects of the present invention are exhibited more significantly, it is preferable that the oxide semiconductor is tin-doped indium oxide.

From the viewpoint that the effects of the present invention are exhibited more significantly, it is preferable that the second electrode layer 15 includes the atom in the inorganic nanoparticles in the light absorbing layer 14, and it is more preferable that the second electrode layer 15 is formed of the same material as the inorganic nanoparticles. For example, in a case where the inorganic nanoparticles in the light absorbing layer 14 are tin-doped indium oxide, it is preferable that the second electrode layer 15 includes at least one atom selected from indium (In) or tin (Sn), and it is preferable that the second electrode layer 15 is tin-doped indium oxide.

The second electrode layer 15 may be a single-layer film or a laminated film including two or more layers.

For example, the second electrode layer 15 can be formed using a vacuum deposition method such as ion plating or ion beam, a physical vapor deposition method (PVD method) such as sputtering, a chemical vapor deposition method (CVD method), or a spin coating method.

The film thickness of the second electrode layer 15 is preferably 1 to 200 nm, more preferably 1 to 100 nm, and still more preferably 1 to 50 nm.

Although not shown in the drawing, in the optical modulation element 2, a protective layer may be provided on the second electrode layer 15. Examples of a material of the protective layer include the above-described dielectric material, a metal oxide, an oxide semiconductor, an organic semiconductor, and a polymer. In addition, although not shown in the drawing, a terminal for applying a voltage may be provided in the first electrode layer 12 and the second electrode layer 15. In addition, in a case where the optical modulation element 2 is used as a reflective optical modulation element, a light reflecting member may be provided on a side of the optical modulation element 2 opposite to an incidence side. For example, in a case where the second electrode layer 15 side is the light incidence side, the light reflecting member may be provided on the substrate 11 side of the optical modulation element 2.

<Optical Shutter>

An optical shutter according to the embodiment of the present invention includes the optical modulation element according to the embodiment of the present invention. The optical shutter according to the embodiment of the present invention can be used for, for example, various apparatuses such as an optical sensor (an image sensor, laser imaging detection and ranging (Lidar), or the like), thermography, or a heat shielding apparatus.

<Optical Modulation Method>

An optical modulation method according to the embodiment of the present invention comprises: dynamically modulating reflected light or transmitted light of light incident into the above-described optical modulation element by changing a voltage to be applied to the light absorbing layer of the optical modulation element.

The voltage to be applied to the light absorbing layer varies depending on the material, the film thickness, and the like of each of the layers of the optical modulation element. For example, the voltage can be set to −50 V to 50 V.

An incidence angle of light into the optical modulation element is not particularly limited and is preferably 0° to 70°, more preferably 0° to 50°, and still more preferably 0° to 30°. The incidence angle refers to an angle between a straight line perpendicular to a surface into which light is incident and incidence light.

### Examples

Hereinafter, the present invention will be described in detail using Examples. Materials, used amounts, ratios, treatment details, treatment procedures, and the like shown in the following examples can be appropriately changed within a range not departing from the scope of the present invention. Accordingly, the scope of the present invention is not limited to the following specific examples.

[Manufacturing of Inorganic Nanoparticle Dispersion Liquid]

### Manufacturing Example of Inorganic Nanoparticle Dispersion Liquid 1

First, 420 mL (396 mmol) of oleic acid (manufactured by Fujifilm Wako Pure Chemical Corporation; purity: 65.0% or more), 56.706 g (194 mmol) of indium acetate (manufactured by Alfa Aesar, purity: 99.99%), and 5.594 g (15.8 mmol) of tin (IV) acetate (manufactured by Alfa Aesar) were put into a flask, and the mixture was heated for 2 hours under a temperature condition of 160° C. in an environment of nitrogen flow to obtain a yellow transparent precursor solution. [Step (I)]

Subsequently, 225 ml of oleyl alcohol (manufactured by Fujifilm Wako Pure Chemical Corporation; purity: 65.0% or more) was added to another flask, and was heated at 285° C. in a nitrogen flow. 187.5 mL of the precursor solution obtained in the step (I) was added dropwise to the heated solution using a syringe pump at a rate of 1.17 mL/min. [Step (II)]

After completion of the dropwise addition of the precursor solution in the step (II), the obtained reaction solution was kept at 285° C. for 30 minutes. [Step (III)]

Thereafter, the heating was stopped, and the reaction solution was cooled to room temperature. The obtained reaction solution was centrifugally separated to remove the supernatant, and was redispersed in toluene. Next, the ethanol addition, the centrifugal separation, the supernatant removal, and the toluene redispersion were repeated three times. As a result, a toluene dispersion liquid (inorganic nanoparticle dispersion liquid 1) where oleic acid as a ligand was coordinated to tin-doped indium oxide (ITO) particles (tin (Sn) concentration: 7.5 at %, average particle diameter: 20 nm) was obtained. [Step (IV)]

### Manufacturing Example of Inorganic Nanoparticle Dispersion Liquid 2

420 mL (396 mmol) of oleic acid (manufactured by Fujifilm Wako Pure Chemical Corporation; purity: 65.0% or more), 60.969 g (208 mmol) of indium acetate (manufactured by Alfa Aesar, purity: 99.99%), and 0.745 g (2.1 mmol) of tin (IV) acetate (manufactured by Alfa Aesar) were put into a flask, and the mixture was heated for 2 hours under a temperature condition of 160° C. in an environment of nitrogen flow to obtain a yellow transparent precursor solution. [Step (I)]

Subsequently, 225 ml of oleyl alcohol (manufactured by Fujifilm Wako Pure Chemical Corporation; purity: 65.0% or more) was added to another flask, and was heated at 285° C. in a nitrogen flow. 187.5 mL of the precursor solution obtained in the step (I) was added dropwise to the heated solution using a syringe pump at a rate of 1.17 mL/min. [Step (II)]

After completion of the dropwise addition of the precursor solution in the step (II), the obtained reaction solution was kept at 285° C. for 30 minutes. [Step (III)]

Thereafter, the heating was stopped, and the reaction solution was cooled to room temperature. The obtained reaction solution was centrifugally separated to remove the supernatant, and was redispersed in toluene. Next, the ethanol addition, the centrifugal separation, the supernatant removal, and the toluene redispersion were repeated three times. As a result, a toluene dispersion liquid (inorganic nanoparticle dispersion liquid 2) where oleic acid as a ligand was coordinated to tin-doped indium oxide (ITO) particles (tin (Sn) concentration: 1 at %, average particle diameter: 21 nm) was obtained. [Step (IV)]

### Manufacturing Example of Inorganic Nanoparticle Dispersion Liquid 3

1400 mg of indium acetylacetonate, 80 mg of cerium acetylacetonate, and 14.4 mL of oleylamine were weighed in a flask, and the mixture was heated in nitrogen flow at 110° C. for 10 minutes. Next, the temperature was increased to 250° C., and the solution was heated for 2 hours. After cooling, an excess amount of ethanol was added, and the solution was centrifugally separated and was redispersed in hexane. As a result, a hexane dispersion liquid (inorganic nanoparticle dispersion liquid 3) of cerium-doped indium oxide particles (average particle diameter: 15 nm) to which oleylamine was coordinated was obtained.

[Manufacturing of Optical Modulation Element]

### Examples 1 to 8

A synthetic quartz substrate was cleaned with ultrasonic waves in ethanol for 5 minutes and in acetone for 5 minutes.

Next, a molybdenum (Mo) film having a thickness of 200 nm was formed on the substrate cleaned with ultrasonic waves using a sputtering method through a metal mask. As a result, a first electrode layer was formed.

Next, in Examples 1 to 7, a SiO₂ film was formed on the first electrode layer by sputtering (high frequency power supply (RF) output: 300 W, distance between the substrates: 130 nm, Ar gas flow rate: 133 sccm, pressure during film formation: 0.5 Pa) such that the film thickness was as shown in a table below. As a result, a dielectric layer was formed.

Next, in Example 8, a HfO₂ film was formed on the first electrode layer by sputtering (high frequency power supply (RF) output: 300 W, distance between the substrates: 130 nm, Ar gas flow rate: 133 sccm, pressure during film formation: 0.5 Pa) such that the film thickness was 300 nm. As a result, a dielectric layer was formed.

Next, in a glove box, A) an inorganic nanoparticle dispersion liquid (particle concentration: about 80 mg/mL) shown in the table below was added dropwise to the dielectric layer formed on the substrate and was spin-coated at 2000 rpm for 20 seconds to form a coating film. B) Next, a methanol solution (0.02 v/v %) of mercaptopropionic acid was added dropwise to the coating film, was left to stand for 60 seconds, and was spin-dried at 2000 rpm for 20 seconds. C) Next, methanol was added dropwise to the coating film and was spin-dried at 2000 rpm for 20 seconds. The steps A) to C) were repeated two times in total to form a light absorbing layer as an inorganic nanoparticle film having a thickness of about 90 nm.

Next, a heat treatment was performed on the substrate on which the light absorbing layer was formed in a glove box at 250° C. for 1 hour. This way, optical modulation elements according to Examples 1 and 3 were manufactured.

In addition, in Examples 2 and 4 to 8, A film of tin-doped indium oxide (ITO) having a thickness of 10 nm was formed using a sputtering method on the light absorbing layer formed as described above after the heat treatment. As a result, a second electrode layer was formed. This way, optical modulation elements according to Examples 2 and 4 to 8 were manufactured.

TABLE 1

| | Kind of Dielectric | Thickness of | Kind of Inorganic Nanoparticle | Second Electrode |
|---|---|---|---|---|
| | Layer | Dielectric Layer | Dispersion Liquid | Layer |
| Example 1 | SiO₂ | 300 nm | Inorganic Nanoparticle | Not Provided |
| | | | Dispersion Liquid 1 | |
| Example 2 | SiO₂ | 300 nm | Inorganic Nanoparticle | Provided |
| | | | Dispersion Liquid 1 | |
| Example 3 | SiO₂ | 300 nm | Inorganic Nanoparticle | Not Provided |
| | | | Dispersion Liquid 2 | |
| Example 4 | SiO₂ | 300 nm | Inorganic Nanoparticle | Provided |
| | | | Dispersion Liquid 2 | |
| Example 5 | SiO₂ | 200 nm | Inorganic Nanoparticle | Provided |
| | | | Dispersion Liquid 1 | |
| Example 6 | SiO₂ | 200 nm | Inorganic Nanoparticle | Provided |
| | | | Dispersion Liquid 2 | |
| Example 7 | SiO₂ | 300 nm | Inorganic Nanoparticle | Provided |
| | | | Dispersion Liquid 3 | |
| Example 8 | HfO₂ | 300 nm | Inorganic Nanoparticle | Provided |
| | | | Dispersion Liquid 2 | |

[Evaluation Method of Optical Characteristics]

Using an infrared spectrophotometer (multi-purpose FTIR VIR-200, manufactured by JASCO Corporation), optical characteristics of an infrared range of the optical modulation element were evaluated. While applying a voltage to the light absorbing layer of the optical modulation element, in order to measure an absorbance of the light absorbing layer with respect to reflected light, a specular reflection unit RF-SC-VIR (manufactured by JASCO Corporation) was disposed on the back surface (substrate side) of the optical modulation element, and the absorbance was measured. In addition, the incidence angle of light into the light absorbing layer of the optical modulation element was 12°. In addition, regarding the optical modulation elements according to Examples 1 to 4, 7, and 8, the absorbance was measured while changing the applied voltage in a range of −50 V to +50 V. In addition, regarding the optical modulation elements according to Examples 5 and 6, the absorbance was measured while changing the applied voltage in a range of −30 V to +30 V.

Focusing on a peak value of a strongest absorbance in a wavelength range of 1.3 to 25 μm, a rate of change of a peak value (A1) of an absorbance during the voltage application to a peak value)(A° of an absorbance in a state (0 V) where a voltage is not applied was calculated from the following expression.

Rate of Change of Absorbance (%)=)(A¹/A⁰)×100−100

In addition, a wavelength (peak wavelength) at which the peak value of the absorbance during the voltage application was investigated, and the amount of change (A1) of the peak wavelength was calculated from the following expression.

Amount of Change of Peak Wavelength (Δλ)=(Peak Wavelength during Voltage Application)−(Peak wavelength in state (0 V) where Voltage is not Applied)

TABLE 2

| | Rate of Change of | | Amount of Change of | |
|---|---|---|---|---|
| | Absorbance by Voltage | | Peak Wavelength (Δλ) | |
| Example 1 | −15% | 6% | 0.10 μm | 0.01 μm |
| | (at +50 V) | (at −50 V) | (at +50 V) | (at −50 V) |
| Example 2 | −20% | 7% | 0.08 μm | 0.01 μm |
| | (at +50 V) | (at −50 V) | (at +50 V) | (at −50 V) |
| Example 3 | 6% | −8% | 0.04 μm | −0.07 μm |
| | (at +50 V) | (at −50 V) | (at +50 V) | (at −50 V) |
| Example 4 | 19% | −12% | 0.04 μm | −0.16 μm |
| | (at +50 V) | (at −50 V) | (at +50 V) | (at −50 V) |
| Example 5 | 10% | −3% | 0.18 μm | −0.09 μm |
| | (at +30 V) | (at −30 V) | (at +30 V) | (at −30 V) |
| Example 6 | 15% | −20% | 0 μm | −0.31 μm |
| | (at +30 V) | (at −30 V) | (at +30 V) | (at −30 V) |
| Example 7 | 11% | −6% | 0.04 μm | −0.11 μm |
| | (at +50 V) | (at −50 V) | (at +50 V) | (at −50 V) |
| Example 8 | 22% | −14% | 0.04 μm | −0.15 μm |
| | (at +50 V) | (at −50 V) | (at +50 V) | (at −50 V) |

As shown in the table, in all of the optical modulation elements according to Examples, the absorbance was able to be changed by changing the applied voltage. In addition, the wavelength at which the peak of the absorbance was shown was also able to be changed by changing the applied voltage. This way, in all of the optical modulation elements according to Examples, the selective absorption of light was able to be changed by changing the applied voltage. Therefore, in the optical modulation elements according to Examples, the intensity or the spectrum of reflected light or transmitted light from the optical modulation element can be changed by changing the voltage to be applied to the light absorbing layer.

In the evaluation of the optical characteristics, the evaluation was performed using reflected light of light incident into the optical modulation element. However, even in a case where the evaluation was performed using transmitted light, the same effects as described above can be obtained.

### EXPLANATION OF REFERENCES

1, 2: optical modulation element
11: substrate
12: first electrode layer
13: dielectric layer
14: light absorbing layer
15: second electrode layer

What is claimed is:

1. An optical modulation element comprising:
a substrate;
an electrode layer provided on the substrate;
a dielectric layer provided on the electrode layer; and
a light absorbing layer provided on the dielectric layer and including inorganic nanoparticles,
wherein the inorganic nanoparticles exhibit localized surface plasmon resonance by light irradiation.

2. The optical modulation element according to claim 1, further comprising:
a second electrode layer provided on the light absorbing layer.

3. The optical modulation element according to claim 2,
wherein the second electrode layer is an oxide semiconductor.

4. The optical modulation element according to claim 2,
wherein the second electrode layer includes tin-doped indium oxide.

5. The optical modulation element according to claim 1,
wherein the inorganic nanoparticles are particles of a semiconductor.

6. The optical modulation element according to claim 5,
wherein the semiconductor is an oxide semiconductor.

7. The optical modulation element according to claim 6,
wherein the oxide semiconductor includes at least one atom selected from indium, zinc, tin, or cerium.

8. The optical modulation element according to claim 1,
wherein the inorganic nanoparticles include tin-doped indium oxide particles.

9. The optical modulation element according to claim 1,
wherein an average particle diameter of the inorganic nanoparticles is 1 to 100 nm.

10. The optical modulation element according to claim 1,
wherein a ligand is coordinated to the inorganic nanoparticles.

11. The optical modulation element according to claim 10,
wherein the ligand includes at least one selected from a ligand including a halogen atom or a multidentate ligand including two or more coordination sites.

12. The optical modulation element according to claim 1,
wherein reflected light or transmitted light of light incident into the optical modulation element is dynamically modulated by changing a voltage to be applied to the light absorbing layer.

13. An optical shutter comprising:
the optical modulation element according to claim 1.

14. An optical modulation method comprising:
dynamically modulating reflected light or transmitted light of light incident into the optical modulation element according to claim 1 by changing a voltage to be applied to the light absorbing layer of the optical modulation element.
